(19) United States
(12) Patent Application Publication
(10) Pub. No.: US 2018/0099382 A1
(43) Pub. Date: Apr. 12, 2018

(54) VISE

(71) Applicant: LUDWIG EHRHARDT GMBH, LAUBACH (DE)

(72) Inventor: REINER HIPPENSTIEL, SIEGEN (DE)

(73) Assignee: LUDWIG EHRHARDT GMBH, LAUBACH (DE)

(21) Appl. No.: 15/556,341

(22) PCT Filed: Jan. 22, 2016
(86) PCT No.: PCT/EP2016/000116

§ 371 Date: Sep. 7, 2017

(30) Foreign Application Priority Data
Mar. 20, 2015 (DE) 10 2015 003 662.9

(51) Int. Cl. B25B 1/10; B25B 1/24

(52) U.S. Cl. CPC B25B 1/103; B25B 1/2489

(57) ABSTRACT

The invention relates to a vise for clamping a workpiece with two clamping jaw holders, each for receiving a clamping jaw for clamping the workpiece between the two clamping jaws, a fixed lower part and a carriage guide for linearly displaceable guidance of at least one of the two clamping jaw holders, wherein the carriage guide has two guide bars which are fastened to the lower part. It is proposed that the guide bars of the carriage guide are fastened laterally to the lower part.

### CROSS REFERENCE TO RELATED APPLICATIONS

This application is a national stage of International Application No. PCT/EP2016/000116 filed Jan. 22, 2016, which is based upon and claims priority to German Patent Application No. DE 10 2015 003 662.9, filed Mar. 20, 2015, the entire contents of all of which are incorporated herein by reference.

### FIELD OF THE INVENTION

The invention relates to a vise for clamping workpieces.

### BACKGROUND OF THE INVENTION

From the prior art, different designs of vises are known which serve to clamp workpieces, for example, for machining of the workpiece in the clamped state.

FIGS. 3A and 3B show different views of a conventional vise 1 which is configured as a fixed-jaw clamp. The vise 1 has two clamping jaw holders 2, 3 onto the upper side of each of which a clamping jaw can be screw fastened, which is per se known from the prior art. The clamping jaw holder 2 is herein immovably fastened to a lower part 5 by means of a tongue-and-groove connection 4, i.e. the clamping jaw holder 2 does not move during a clamping procedure. The other clamping jaw holder 3, however, is displaced in the direction of the double arrow during a clamping procedure. For this purpose, the clamping jaw holder 3 is mounted on a displaceable carriage 6, which is guided in the lower part 5 in the direction of the double arrow. For displaceable guidance of the carriage 6, the vise has a carriage guide which consists substantially of tongues 7, 8 formed laterally on the carriage 6, the tongues 7, 8 being arranged in corresponding longitudinal grooves in the upwardly extending limbs of the substantially U-shaped lower part 5. The displacement of the clamping jaw holder 3 is herein caused by rotation of a spindle 9, which is per se known from the prior art.

FIGS. 4A and 4B show another exemplary embodiment of a conventional vise 1, this exemplary embodiment partially matching the above-described exemplary embodiment shown in FIGS. 3A and 3B so that, for the avoidance of repetition, reference is made to the above description, wherein for corresponding details, the same reference signs are used.

A peculiarity consists therein that the fixed clamping jaw holder 2 is fastened to the lower part 5 by a screw fastening.

A further peculiarity consists therein that the carriage 6 is displaceably guided without the lateral tongues 7, 8 in the lower part 5.

FIGS. 5A and 5B show another exemplary embodiment of a conventional vise 1, which partially matches the above-described conventional exemplary embodiments so that, for the avoidance of repetition, reference is made to the above description, wherein for corresponding details, the same reference signs are used.

A peculiarity of this exemplary embodiment consists therein that the spindle 9 is axially fixed by a bolt 10, the bolt 10 being fitted from below into a vertical bore in the lower part 5 and protruding upwardly into an annular groove 11 in the spindle 9, by which means the spindle 9 is fixed in the axial direction.

A further peculiarity of this exemplary embodiment consists therein that the tongues 7, 8 are arranged on the carriage 6 abutting the underside of the carriage 6 and not—as in the FIGS. 3A and 3B—in the vertical direction in the middle of the carriage 6.

FIGS. 6A and 6B show another exemplary embodiment of a conventional vise 1, which also partially matches the above-described exemplary embodiments so that, for the avoidance of repetition, reference is made to the above description, wherein for corresponding details, the same reference signs are used.

A peculiarity of this exemplary embodiment consists therein that the carriage guide has guide bars 12, 13 for the linearly displaceable guidance of the carriage 6, which are screwed with fastening screws 14, 15 from above onto the upwardly extending limbs of the U-shaped lower part 5, the guide bars 12, 13 holding the carriage 6 in the lower part 5.

The above-described known vises 1 have various disadvantages, however. Of particular significance, however, is the fact that the carriage guide of the carriage 6 always has an unavoidable vertical play. This means that the carriage 6 and thus also the clamping jaw holders 2, 3 and the clamping jaws mounted thereon have a vertical play. This vertical play of the clamping jaws can again lead to crooked clamping of the workpiece.

### SUMMARY OF THE INVENTION

It is therefore an object of the invention to minimize the undesired vertical play of the clamping jaws in a vise of this type.

This object is achieved with an inventive vise according to the main claim.

In agreement with the prior art, the inventive vise has two clamping jaw holders on each of which a clamping jaw can be mounted, which is per se known from the prior art. For example, the clamping jaws can be screw fastened to the clamping jaw holders. However, with regard to the type of fastening of the clamping jaws to the clamping jaw holders, the invention is not restricted to a screw fastening.

Furthermore, in accordance with the prior art, the inventive vise includes a fixed lower part.

Furthermore, in accordance with the prior art, the inventive vise includes a carriage guide, in order to guide at least one clamping jaw holder displaceably.

It should be mentioned herein that the inventive vise can optionally be configured as a self-centring clamp or a fixed-jaw clamp. In a fixed-jaw clamp, one of the two clamping jaw holders is arranged immovably, whereas the other clamping jaw holder is displaceable in order to clamp a workpiece. In a self-centring clamp, however, both clamping jaw holders are displaceable linearly and are moved contradirectionally.

In accordance with the prior art, in the inventive vise, the carriage guide has at least two guide bars which are fastened to the lower part.

In contrast to the known exemplary embodiment, however, according to FIGS. 6A and 6B, the guide bars in the inventive vise are not fastened to the upper side of the lower part, but are fastened laterally to the lower part of the vise. This is advantageous because thereby the vertical height play of the clamping jaw holder can be reduced almost to zero, as described in detail below.

In a preferred exemplary embodiment of the invention, the guide bars are each screw fastened laterally by at least one fastening screw to the lower part, wherein the fastening screws of the guide bars can each be oriented horizontally. The inventive vise therefore differs from the prior art by the orientation of the fastening screws for fastening the guide bars.

It should herein be mentioned that in the pre-mounted state, the guide bars do not lie with their underside on the lower part. The pre-mounted state is herein the state in which the fastening of the guide bars is not yet tightened. Rather, a gap (e.g. 1/10 mm- 2/10 mm) then remains between the underside of the guide bars and the upper side of the lower part, which in the pre-mounted state enables a vertical positioning of the guide bars relative to the lower part in order to reduce the height play of the carriage guide, in particular to zero. In the context of the pre-assembly, the guide bars are thus initially loosely attached. Subsequently, the guide bars are then pressed so far downwardly until the vertical play of the carriage is reduced almost to zero. Subsequently, the guide bars are then fastened to the lower part, for example, by tightening the fastening screws. This advantageously enables the height play of the carriage and thus also the unwanted height play of the clamping jaws to be reduced, independently of manufacturing tolerances, almost to zero.

In a preferred exemplary embodiment of the invention with fastening screws for mounting of the guide bars onto the lower part, in the pre-mounted state, the fastening screws preferably enable a vertical play of the guide bars relative to the fastening screws. This means that the guide bars can still be positioned in the vertical direction before the tightening of the fastening screws, in order to reduce the unwanted height play.

For this purpose, the guide bars preferably have horizontally extending through holes in order to be able to guide the fastening screws therethrough. It is herein advantageous if the internal diameter of these through holes is larger in the guide bars than the outer diameter of the fastening screws. In this way, therefore, the possibility exists that the guide bars can still be positioned in the vertical direction following the insertion of the fastening screws and before the tightening of the fastening screws, in order to reduce the unwanted height play.

In a preferred exemplary embodiment of the invention, the guide bars each have a horizontal limb which grasps the clamping jaw holders above in order to prevent an upward movement of the clamping jaw holders. In addition, the guide bars preferably also have a vertical limb which grasps the clamping jaw holders laterally outwardly in order to prevent a lateral movement of the clamping jaw holders. The guide bars thus preferably have a cross-section which is substantially L-shaped.

It should also be mentioned here that the guide bars can extend over the whole length of the vise. However, alternatively, the possibility also exists that a plurality of guide bars are arranged along the length of the vise behind one another.

In a preferred exemplary embodiment of the invention, the guide bars together with the lower part form a longitudinal groove in which laterally formed tongues in the clamping jaw holders engage. Thus in the inventive vise, the carriage guide preferably has a tongue-and-groove connection which enables a displacement of the carriage with the movable clamping jaw holder relative to the fixed lower part and the fixed guide bars.

In a configuration of the inventive vise as a fixed-jaw clamp, the displacement of the displaceable clamping jaw holder is preferably caused by a rotatable spindle, which is per se known from the prior art. The rotatable spindle is herein rotatably mounted in a spindle mounting, which is also known from the prior art. Preferably, however, this spindle mounting takes place exclusively through a screwthread engagement of the spindle in the two clamping jaw holders. The inventive fixed-jaw clamp thus preferably has no separate rotary bearing for mounting the spindle. In addition, the inventive fixed-jaw clamp preferably also has no separate axial fixing to fix the spindle in the axial direction.

The fixing of the immovable clamping jaw holder to the lower part can take place in the inventive fixed-jaw clamp—as in the known exemplary embodiment according to FIGS. 3A and 3B—for example, by means of a tongue-and-groove connection that is oriented transversely to the clamping direction. However, alternatively, the possibility also exists that the immovable clamping jaw holder is screw fastened to the lower part. Furthermore, in the context of the invention, other fastening types in order to fasten the immovable clamping jaw holder to the lower part are also possible.

In the inventive fixed-jaw clamp, the screwthread engagements of the spindle in the two clamping jaw holders are contradirectional, so that a rotation of the spindle in one rotary direction pulls the clamping jaw holders together, whereas a rotation of the spindle in the opposite rotary direction pulls the two clamping jaw holders apart. In the preferred exemplary embodiment of the invention, in the screwthread engagement with the immovable clamping jaw holder, the spindle has a right-handed thread and in the screwthread engagement with the displaceable clamping jaw holder, it has a left-handed thread.

In a fixed-jaw clamp according to the invention, the immovable clamping jaw holder is preferably clamped in the lateral direction between the guide bars with a press fit in order to fix the immovable clamping jaw holder immovably. The displaceable clamping jaw holder, however, is preferably clamped in the lateral direction between the guide bars with a clearance fit in order to enable a displacement of the displaceable clamping jaw holder.

Alternatively, however, the possibility also exists in the context of the invention that the vise is configured as a self-centring clamp wherein both clamping jaw holders are displaceable. Herein also, the displacement of the clamping jaw holders preferably takes place by means of a rotatable spindle which is rotatably mounted in a spindle mounting. However, an axial fixing is herein preferably provided, which fixes the spindle axially in the vise.

In a preferred exemplary embodiment of the invention, in the vise configured as a self-centring clamp, the axial fixing engages on the spindle on one side only in the region of one of the two displaceable clamping jaw holders and does not extend into the intermediate space between the two clamping jaw holders. This is advantageous since the axial fixing would otherwise lead, in an arrangement in the intermediate space between the two clamping jaw holders, thereto that the intermediate space is fissured, so that chips could accumulate there. For this reason, it is also advantageous if the spindle has a smooth thread-free outer surface in the intermediate space between the two clamping jaw holders.

The axial fixing of the spindle mounting can take place, for example—as in the known exemplary embodiment of FIGS. 5A and 5B—by means of a bolt which is introduced from below into the lower part of the vise and engages with its free end at the top in an annular groove in the spindle, in order to fix the spindle axially.

The possibility exists herein that the bolt causes not only an axial fixing of the spindle, but also forms a bearing shell for rotatable mounting of the spindle.

### BRIEF DESCRIPTION OF THE DRAWINGS

Other advantages of the invention are characterized in the subclaims or are described below together with the description of the preferred exemplary embodiments of the invention based upon the drawings, in which:

FIG. 1A is a cross-sectional view through a first exemplary embodiment of an inventive vise transverse to the clamping direction along the section line B-B in FIG. 1C,

FIG. 1B is a perspective view of the vise of FIG. 1A,

FIG. 1C is a longitudinal section through the vise of FIGS. 1A and 1B along the section line A-A in FIG. 1D,

FIG. 1D is a plan view of the vise of FIGS. 1A-1C,

FIG. 2A is a cross-sectional view through another exemplary embodiment of an inventive vise transverse to the clamping direction,

FIG. 2B is a perspective view of the vise of FIG. 2A,

FIG. 2C is a longitudinal section through the vise of FIGS. 2A and 2B along the section line A-A in FIG. 2D,

FIG. 2D is a plan view of the vise of FIGS. 2A-2C,

FIG. 3A is a cross-sectional view through a conventional vise,

FIG. 3B is a perspective view of the conventional vise of FIG. 3A,

FIG. 4A is a cross-sectional view through another exemplary embodiment of a conventional vise,

FIG. 4B is a perspective view of the conventional vise of FIG. 4A,

FIG. 5A is a cross-sectional view through another conventional exemplary embodiment of a known vise,

FIG. 5B is a perspective view of the vise of FIG. 5A,

FIG. 6A is a cross-sectional view through a further conventional exemplary embodiment of a known vise,

FIG. 6B is a perspective view of the vise of FIG. 6A, and

FIGS. 7A-7E are different views of a further exemplary embodiment of an inventive vise.

### DETAILED DESCRIPTION OF A PREFERRED EMBODIMENT

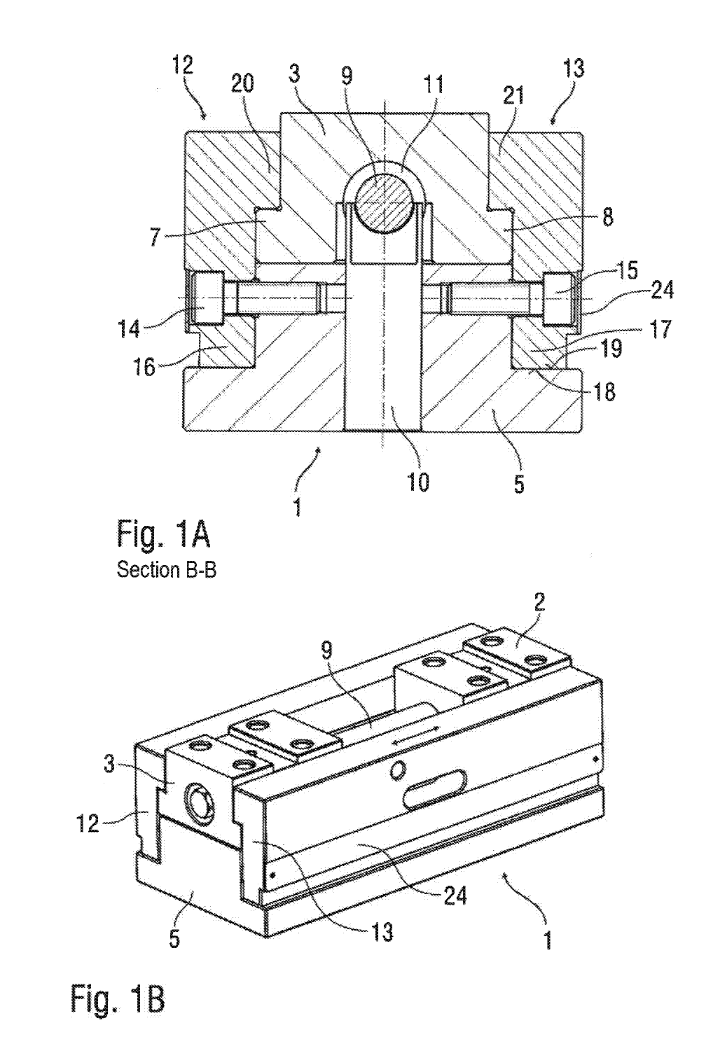

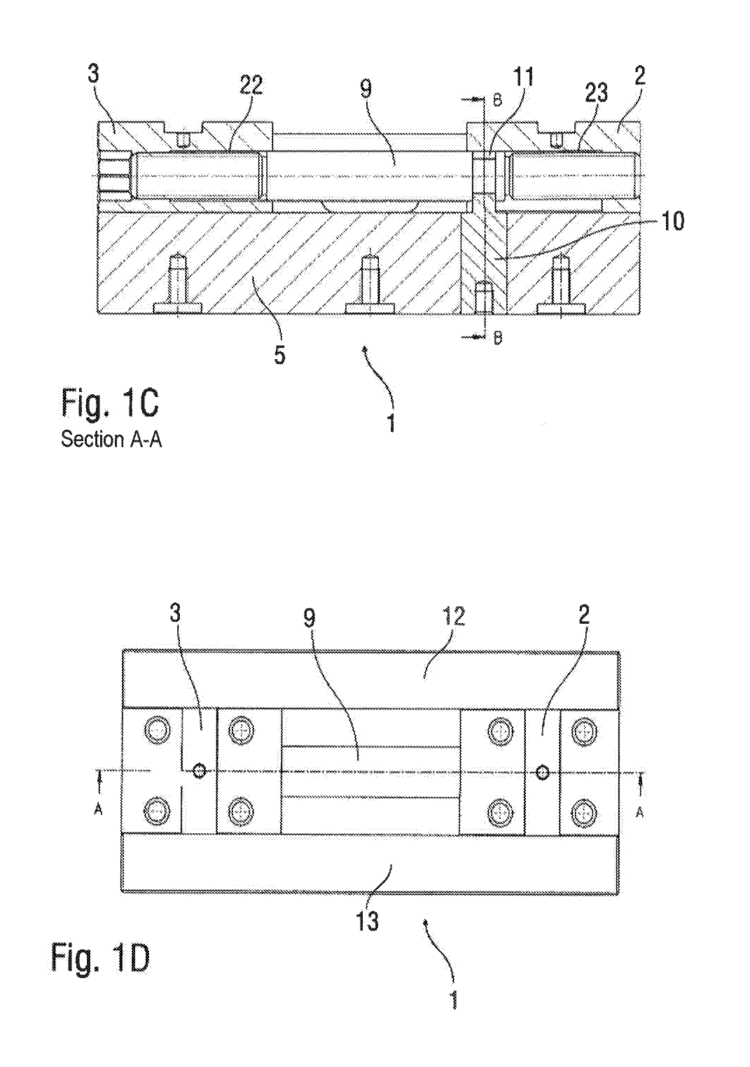

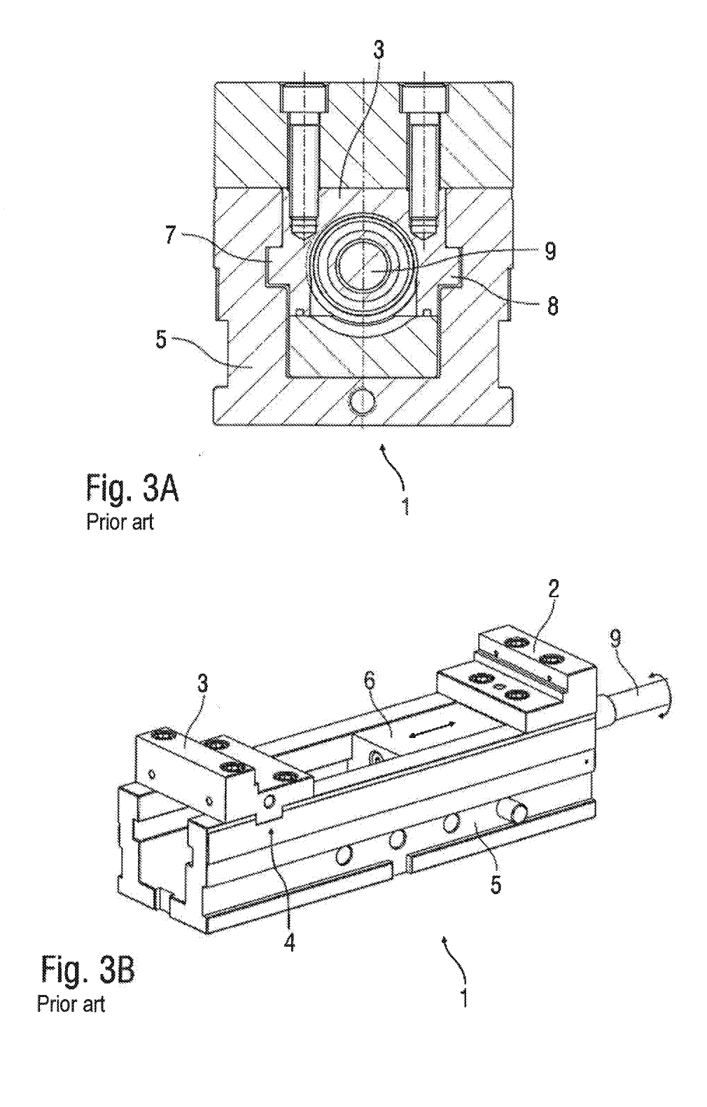

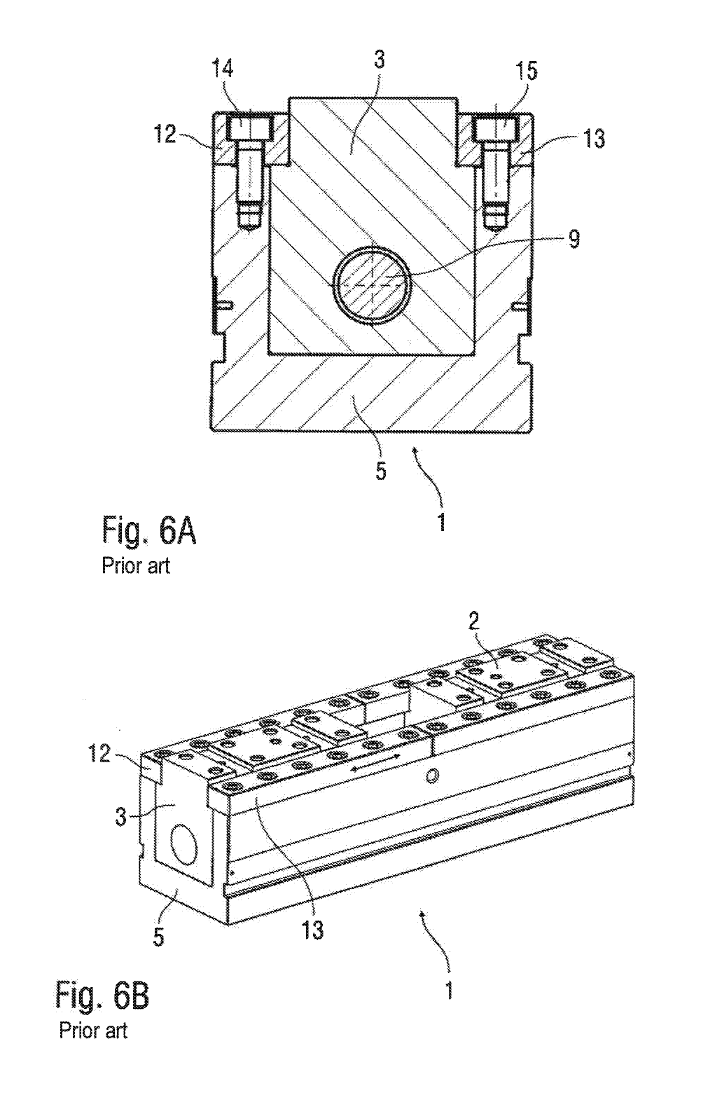

FIGS. 1A-1D show different views of a first exemplary embodiment of an inventive vise 1 which partially matches the conventional vises 1 mentioned in the introduction and shown in FIGS. 3A-6B, so that for the avoidance of repetition, reference is made to the above description of the conventional vises 1, wherein the same reference signs are used for corresponding details.

The inventive vise 1 is configured in this exemplary embodiment as a self-centring clamp. This means that both clamping jaw holders 2, 3 are displaceable in the direction of the double arrow.

A peculiarity of this exemplary embodiment lies in the carriage guide for displaceable guidance of the two clamping jaw holders 2, 3. For this purpose, the carriage guide has the two substantially L-shaped guide bars 12, 13 which are screw fastened laterally to the lower part 5 by means of the fastening screws 14, 15. For this purpose, the two guide bars 12, 13 each have a vertical limb 16, 17, the two vertical limbs 16, 17 each having a through hole for the passing through of the two fastening screws 14, 15. It is herein important that the internal diameter of the two through holes in the two vertical limbs 16, 17 is larger than the external diameter of the two fastening screws 14, 15. This offers the advantage that the guide bars 12, 13 can still be height-adjusted in the pre-mounted stated, i.e. before the tightening of the two fastening screws 14, 15 in order to reduce the unwanted height play of the two clamping jaw holders 2, 3 almost to zero.

In this regard, it should be mentioned that the vertical limbs 16, 17 of the two guide bars 12, 13 do not lie with their underside 18 directly on the upper side 19 of the laterally protruding limb of the lower part 5. Rather, there remains between, firstly, the upper side 19 of the lower part 5 and, secondly, the underside 18 of the vertical limb 16, 17, an air gap so that the guide bars 12, 13 can still be height-adjusted in the pre-mounted state.

On mounting, therefore, the guide bars 12, 13 are loosely mounted, the fastening screws 14, 15 being only loosely tightened. Subsequently, the guide bars 12, 13 are then pressed so far downwardly until the clamping jaw holders 2, 3 have no more height play. In this state, the fastening screws 14, 15 are then tightened firmly, so that the guide bars 12, 13 are fixed in a height position in which almost no height play of the clamping jaw holders 2, 3 remains.

It should also be mentioned that the substantially L-shaped guide bars 12, 13 also each have a horizontal limb 20, 21 which grasps the top of the laterally protruding tongues 7, 8 on the clamping jaw holders 2, 3.

From the longitudinal section of FIG. 1C, it is also apparent that the spindle 9 is located in each of the clamping jaw holders 2, 3 in a screwthread engagement 22 or 23 with the respective clamping jaw holder 2, 3, wherein the two screwthread engagements 22, 23 are contradirectional.

It should also be mentioned that the vise 1 has an axial fixing in order to fix the spindle 9 axially. This axial fixing consists substantially of the bolt 10 which is introduced from below into the lower part 5 and engages with its free end in the annular groove 11 in the spindle 9 and the spindle 9 is thereby fixed in the axial direction. The bolt 10 is herein arranged in the vise 1 on one side in the region of the clamping jaw 2 and does not extend as far as into the intermediate space between the two clamping jaw holders. This is advantageous since the intermediate space between the two clamping jaw holders would otherwise be fissured due to the axial fixing and would then be more susceptible to dirt ingress. For this reason, the spindle 9 has a smooth, thread-free outer surface in the intermediate space between the two clamping jaw holders 2, 3.

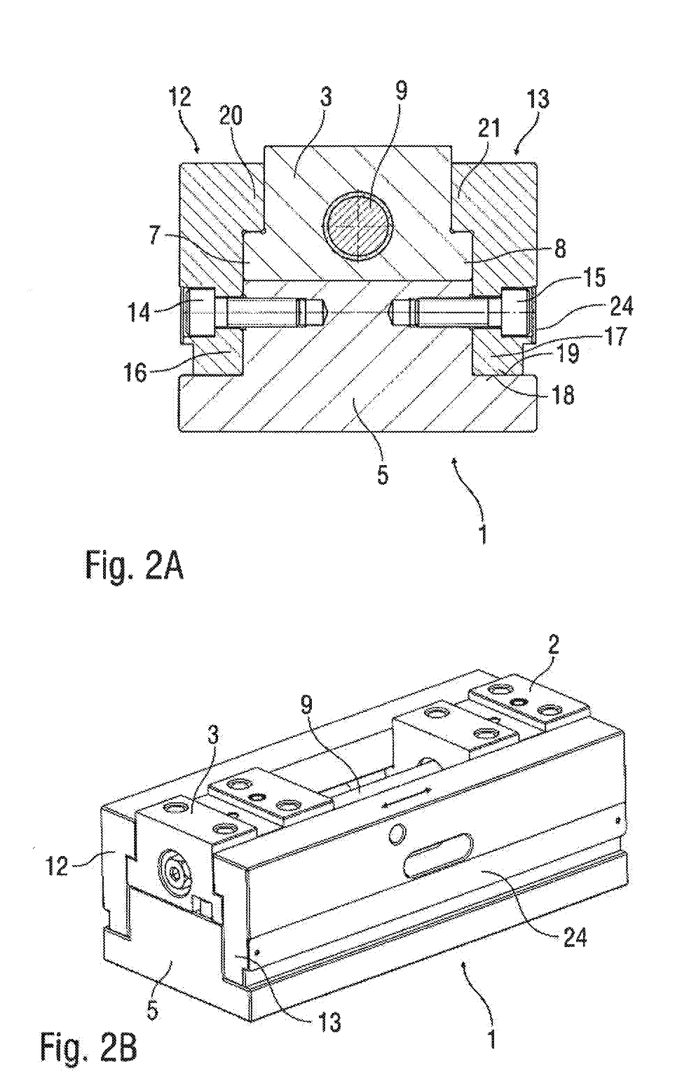

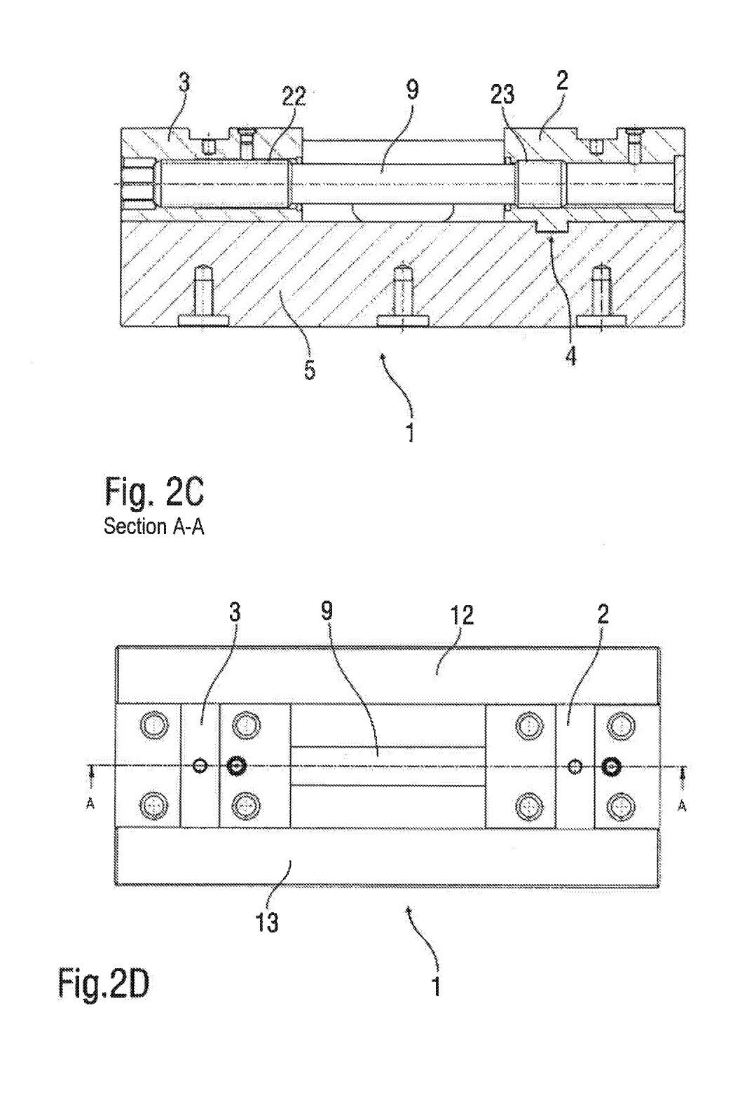

FIGS. 2A-2D show a second exemplary embodiment of an inventive vise 1, which partially matches the above-described vises 1 so that, for the avoidance of repetition, reference is made to the above description, wherein for corresponding details, the same reference signs are used.

The vise 1 is configured in this exemplary embodiment as a fixed-jaw clamp. This means that the clamping jaw 2 is immovably fastened to the lower part 5 and does not move during a clamping procedure. For this purpose, the clamping jaw 2 is connected to the lower part 5 by means of the tongue-and-groove connection 4.

The other clamping jaw holder 3, however, can be displaced in the direction of the double arrow by rotation of the spindle 9.

In relation to this fixed-jaw clamp according to FIGS. 2A-2D, it should further be mentioned that the guide bars 12, 13 respectively grasp the two clamping jaw holders 2, 3 laterally outwardly with a particular tolerance. In the case of the immovable clamping jaw holder 2, this tolerance is dimensioned so that the guide bars 12, 13 clamp the immovable clamping jaw holder 2 with a press fit, so that the immovable clamping jaw 2 is fixed. In the case of the displaceable clamping jaw holder 3, however, this tolerance is dimensioned so that the guide bars 12, 13 grasp the displaceable clamping jaw holder 3 with a clearance fit, so that the displaceable clamping jaw 3 is not firmly clamped by the guide bars 12, 13, but is displaceable.

Furthermore, it is noteworthy regarding the two inventive vises 1 that in the mounted state, the fastening screws 14, 15 are hidden behind a cover 24.

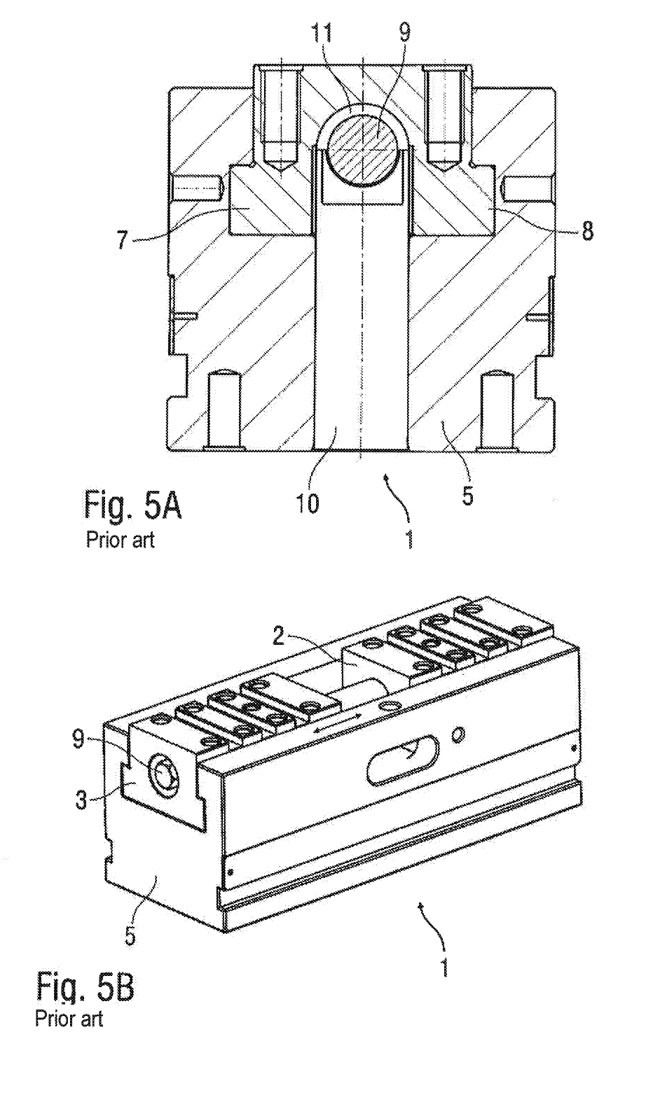

A further advantage of the two inventive vises 1 lies also therein that all the surfaces are accessible for surface grinding and for heat treatment. In contrast thereto, for example, the longitudinal grooves of the carriage guide in FIGS. 3A and 5A are accessible only with difficulty for subsequent material processing.

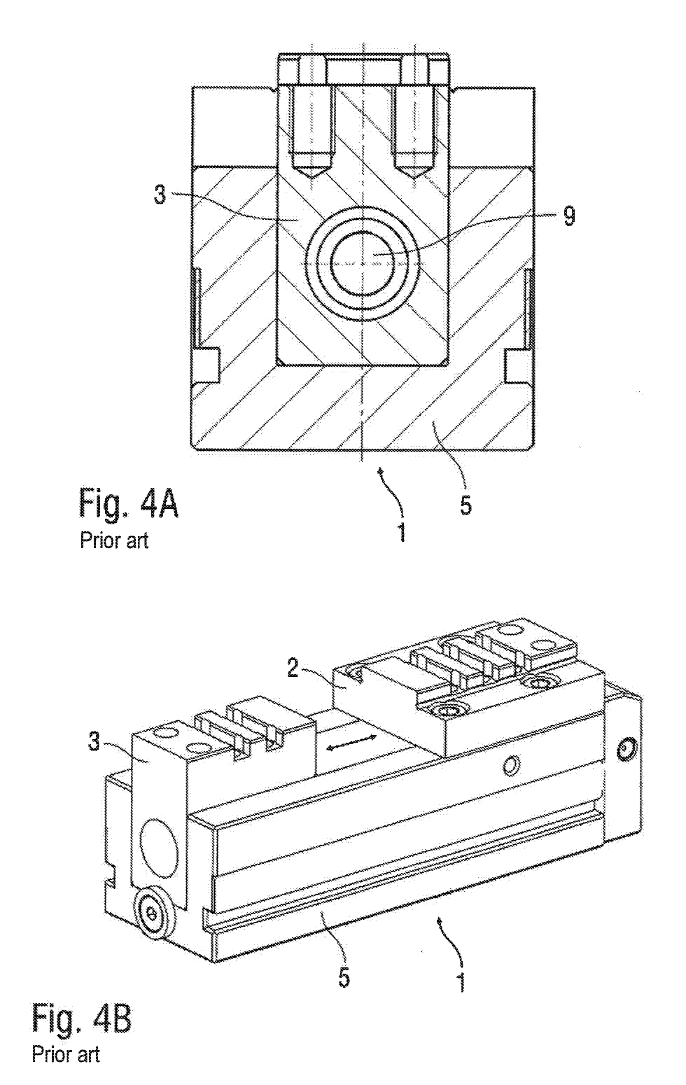

It should also be mentioned that in the two inventive vises 1, the two clamping jaw holders 2, 3 are held down in the vertical direction only by the guide bars. In contrast, the immovable clamping jaw holder 2 in the prior art of FIGS. 3A, 3B and 4A, 4B is firmly screwed to the lower part 5, whereas the displaceable clamping jaw holder 3 is held in the vertical direction by the carriage guide. In the prior art, this has the consequence that, during a clamping procedure, the immovable clamping jaw holder 2 yields differently from the displaceable clamping jaw holder 3, so that the workpiece is clamped slightly crookedly. In the inventive vises 1, however, both clamping jaw holders 2, 3 are held vertically by the guide bars 12, 13 and therefore also yield evenly during a clamping procedure. This even yielding of the two clamping jaw holders 2, 3 is also advantageous because the workpiece is thereby clamped straight.

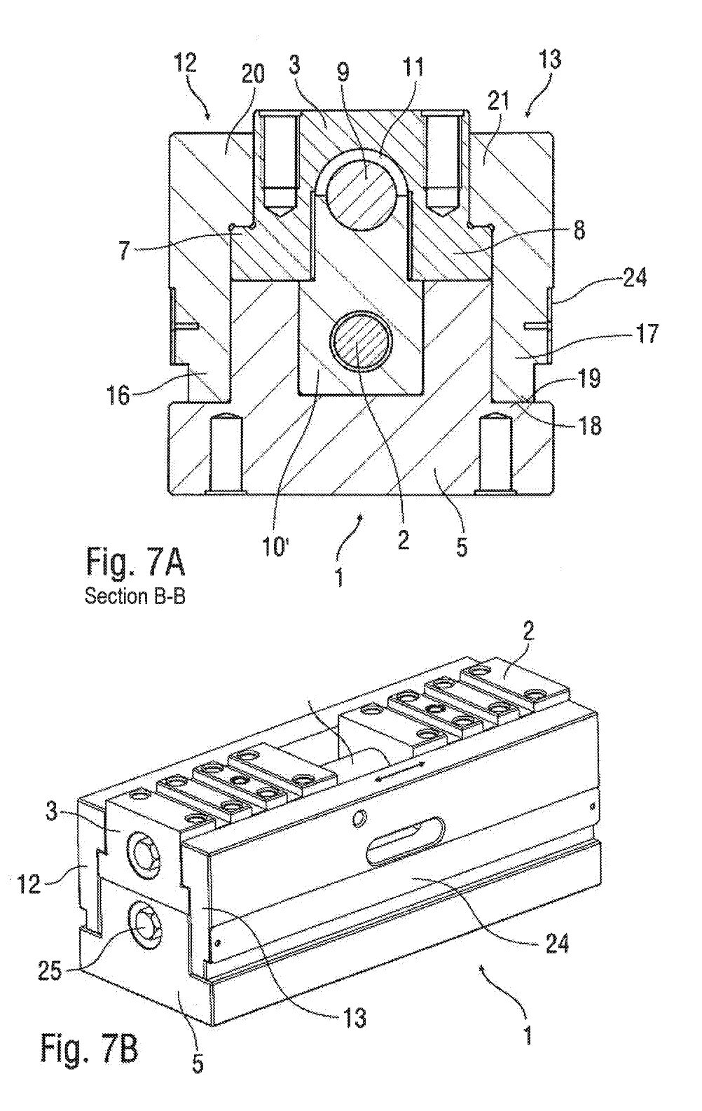

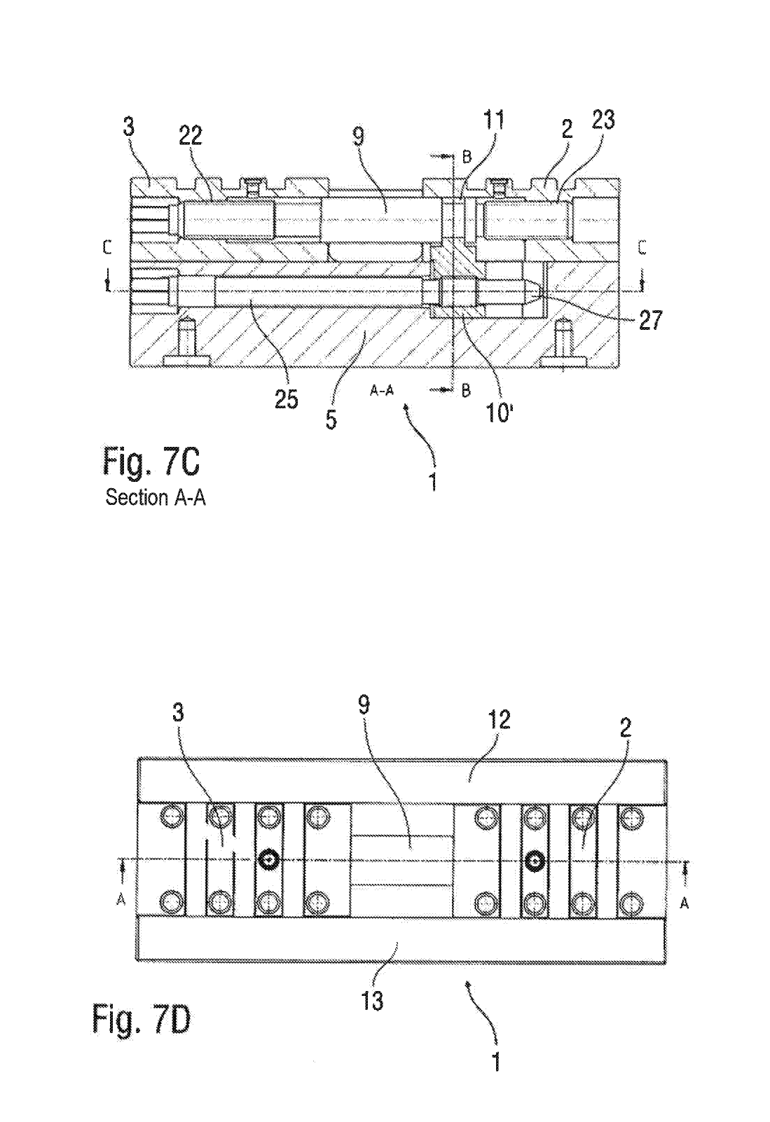

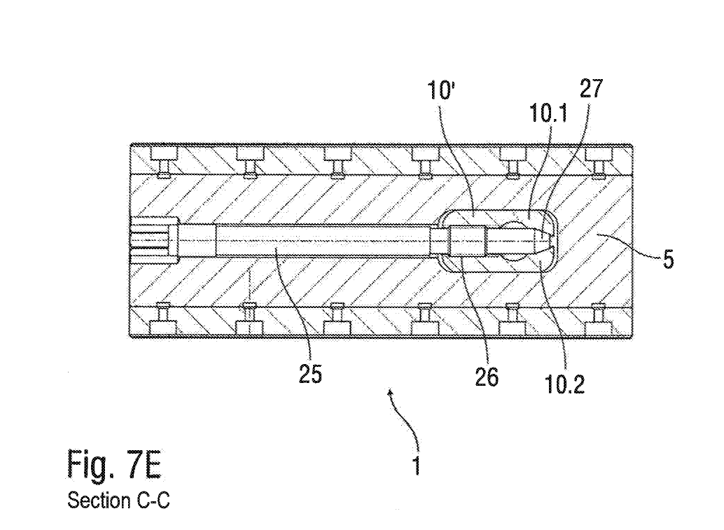

FIGS. 7A-7E show different views of a further exemplary embodiment of an inventive vise 1, wherein this exemplary embodiment partially matches the exemplary embodiment of FIGS. 1A-1D. For the avoidance of repetition, reference is therefore made to the above description, wherein for corresponding details, the same reference signs are used.

A peculiarity of this exemplary embodiment lies therein that the vise 1 avoids mechanical over-rigidity which can otherwise arise if long workpieces (e.g. rails, profiles) are clamped by a plurality of vises arranged adjoining one another along the length of the workpiece to be clamped. The long workpieces to be clamped typically have lateral deviations. If the vises adjacently arranged are oriented precisely along one line, then the lateral deviations of the workpiece to be clamped lead to mechanical tensions since the overall system is mechanically over-rigid.

Another known possibility for preventing such tensions lies in loosening the individual vises from the base before the clamping procedure and then aligning them relative to the workpiece to be clamped.

A known possibility for preventing such tensions lies in arranging the vises on a displacement devise which enables an alignment of the vises in relation to the workpiece to be clamped. However, the whole structure becomes higher and heavier as a result.

In this variant, the inventive vise 1 also enables the prevention of such tensions on clamping a long workpiece (e.g. a rail). In place of the bolt 10 for axially fixing the spindle 9, the vise 1 therefore has a clamping element 10′ which engages with its upper side in the annular groove 11 in the spindle 9 so that the clamping element 10′ can fix the spindle 9 axially.

The clamping element 10′ is arranged in the lower part 5 with a particular axial play, i.e. the clamping element 10′ is displaceable in the axial direction in the lower part 5 according to the axial play.

Furthermore, the clamping element 10′ has an axial bore through which a locking spindle 25 is guided. The axial bore in the clamping element 10′ has an internal thread which is in screwthread engagement 26 with an external thread on the outer surface of the locking spindle 25. A rotation of the locking spindle 25 thus leads to a corresponding axial displacement of the clamping element 10′.

The clamping element 10′ has two arms 10.1, 10.2 which are laterally widenable by the locking spindle 25, i.e. in FIG. 7E upwardly and downwardly respectively, in order to clamp the clamping element 10′ firmly in the lower part 5. For this purpose, the locking spindle 25 has a conical end 27 which tapers toward its free end.

If the locking spindle 25 is screwed with its conical end 27 into the clamping element 10′, the conical end 27 pushes the two arms 10.1, 10.2 of the clamping element 10′ apart laterally, so that the clamping element 10′ is firmly clamped in the lower part 5. The axially fixed clamping element 10′ then also fixes the spindle 9 in the axial direction.

If, however, the locking spindle 25 is screwed out of the clamping element 10′, then this clamping is released and the clamping element 10′ is again displaceable axially within its axial play. This has the result that the spindle 9 is then also axially displaceable again.

In a clamping procedure, the long workpiece (e.g. rail) is initially placed into the released vises 1. The axial fixing of the clamping element 10′ is therein released. Subsequently, the workpiece is clamped by a rotation of the spindles 9 on the individual vises 1, wherein the axial fixing of the spindles 9 is still released. Finally, the axial fixing of the spindles 9 is locked, so that the workpiece is firmly clamped without mechanical over-rigidity.

The invention is not restricted to the above described preferred exemplary embodiments. Rather a plurality of variants and derivations is possible which also make use of the inventive concepts and therefore fall within the protective scope. In particular, the invention also claims protection for the subject matter and the features of the subclaims independently of the claims to which they refer and, in particular, also without the features of the main claim. For example, the exemplary embodiment according to the FIGS. 7A-7E also enjoys protection regardless of the other aspects of the invention, i.e. also independently of the design configuration of the carriage guide with guide bars.

1-17. (canceled)

18. A vise for clamping a workpiece, comprising:
two clamping jaw holders, each adapted for receiving a clamping jaw for clamping the workpiece between the two clamping jaws,
a fixed lower part, and
a carriage guide adapted for linearly displaceable guidance of at least one of the two clamping jaw holders, wherein the carriage guide has two guide bars which are fastened to the lower part,
wherein the guide bars of the carriage guide are fastened laterally to the lower part.

19. The vise according to claim 18, wherein the guide bars are each screw fastened laterally to the lower part by means of at least one fastening screw.

20. The vise according to claim 19, wherein the fastening screws of the guide bars are each oriented horizontally.

21. The vise according to claim 18, wherein a gap lies in the vertical direction between the guide bars and the lower part, so that the guide bars do not lie with their underside on the lower part which, in the pre-mounted state, enables a vertical positioning of the guide bars relative to the lower part in order to reduce the height play of the carriage guide.

22. The vise according to claim 20, wherein the fastening screws of the guide bars in the pre-mounted state each enable a vertical play of the guide bars relative to the fastening screws when the fastening screws are inserted, but not yet tightened.

23. The vise according to claim 22, wherein
arranged in each of the guide bars is a horizontally extending through hole with a particular internal diameter in order to be able to guide the fastening screws therethrough, and
the fastening screws of the guide bars each have an external diameter that is smaller than the internal diameter of the through holes, in order to enable, in the pre-mounted state of the fastening screws, the vertical play of the guide bars relative to the fastening screws.

24. The vise according to claim 18, wherein
the guide bars each have a horizontal limb which grasps the top of the clamping jaw holders to prevent an upward movement of the clamping jaw holders, and
the guide bars each have a vertical limb which grasps the clamping jaw holders laterally outwardly, in order to prevent a lateral movement of the clamping jaw holders.

25. The vise according to claim 18, wherein the guide bars each have a substantially L-shaped cross-section.

26. The vise according to claim 18, wherein the guide bars each extend over the whole length of the vise.

27. The vise according to claim 18, wherein
the guide bars together with the lower part form a longitudinal groove, and
at least one of the displaceable clamping jaw holder and the immovably fixed clamping jaw holder comprises a tongue laterally which engages in the longitudinal groove and forms a tongue-and-groove connection.

28. The vise according to claim 18, wherein
the vise is configured as a fixed-jaw clamp so that one clamping jaw holder is linearly displaceable in the carriage guide, whereas the other clamping jaw holder is immovably fastened to the lower part, and
the immovable clamping jaw holder is fixed in the vertical direction to the lower part only by the guide bars without a screw fastening, so that the two clamping jaw holders are raised evenly during a clamping procedure.

29. The vise according to claim 28, wherein
the vise configured as a fixed-jaw clamp has a rotatable spindle in order to position the clamping jaw holders relative to one another,
the spindle is rotatably mounted in a spindle mounting, and
the spindle mounting is carried out exclusively by means of a screwthread engagement of the spindle in the two clamping jaw holders, so that the vise configured as a fixed-jaw clamp has no separate rotary bearing for mounting the spindle and/or no separate axial fixation for axial fixing of the spindle.

30. The vise according to claim 29, wherein
the immovable clamping jaw holder is axially fixed by a tongue-and-groove connection to the lower part, and
the tongue and the groove of the tongue-and-groove connection are oriented transversely to the clamping direction.

31. The vise according to claim 30, wherein the screwthread engagements of the spindle in the two clamping jaw holders are contradirectional, so that a rotation of the spindle in one rotary direction pulls the clamping jaw holders together, whereas a rotation of the spindle in the opposite rotary direction pulls the two clamping jaw holders apart.

32. The vise according to claim 31, wherein in the screwthread engagement with the immovable clamping jaw holder, the spindle has a right-handed thread and, in the screwthread engagement with the displaceable clamping jaw holder, it has a left-handed thread.

33. The vise according to claim 28, wherein
the immovable clamping jaw holder is clamped in the lateral direction between the guide bars with a press fit in order to fix the immovable clamping jaw holder immovably, and
the displaceable clamping jaw holder is clamped in the lateral direction between the guide bars with a clearance fit in order to enable a displacement of the displaceable clamping jaw holder.

34. The vise according to claim 18, wherein
the vise is configured as a self-centring clamp so that the two clamping jaw holders are displaceable,
the vise comprises a rotatable spindle in order to position the clamping jaw holders relative to one another,
the spindle is rotatably mounted in a spindle mounting, and
the spindle mounting has an axial fixing which fixes the spindle axially in the vise.

35. The vise according to claim 34, wherein in the vise configured as a self-centring clamp, the axial fixing engages on the spindle on one side only in the region of one of the two displaceable clamping jaw holders and does not extend into the intermediate space between the two clamping jaw holders and.

36. The vise according to claim 35, wherein the spindle has a thread-free outer surface in the intermediate space between the two clamping jaw holders.

37. The vise according to claim 35, wherein the axial fixing of the spindle mounting comprises a bolt which is introduced from below into the lower part of the vise and engages with its free end at the top in an annular groove in the spindle in order to fix the spindle axially.

38. The vise according to claim 37, wherein with its free end, the bolt forms a bearing shell for rotatable mounting of the spindle.

39. The vise according to claim 34, wherein
the axial fixing of the spindle is optionally releasable or lockable,
in the released state of the axial fixing, the spindle is axially movable with the clamping jaw holders, and
in the locked state of the spindle, the spindle is axially fixed.

40. The vise according to claim 39, wherein
for releasing or locking the axial guidance of the spindle, a rotatable locking spindle is provided, and
the locking spindle is arranged parallel to the spindle, and
the locking spindle is arranged under the spindle, and
the locking spindle is rotatably mounted in the lower part.

41. The vise according to claim 40, wherein
the axial fixing of the spindle is connected to the clamping element in the lower part,
in the locked state of the axial fixing in the lower part, the clamping element is firmly clamped so that the axial fixing of the spindle is axially fixed,
in the released state of the axial fixing in the lower part, the clamping element is movable axially so that the axial fixing enables an axial movement of the spindle,
the locking spindle has a conical end which tapers toward its free end,
the locking spindle engages with its conical end in the clamping element which is laterally expandable,
in that in the locked state of the clamping element, the conical end of the locking spindle laterally expands the clamping element, so that the clamping element is firmly clamped in the lower part, and
in the released state of the clamping element, the conical end of the locking spindle does not expand laterally, so that the clamping element is axially displaceable in the lower part.
